(19) United States
(12) Patent Application Publication
(10) Pub. No.: US 2001/0009021 A1
(43) Pub. Date: Jul. 19, 2001

(54) Network powered computer system and components

(76) Inventors: William Woollcott Ellington JR., Raleigh, NC (US); Francis Edward Noel JR., Durham, NC (US)

Correspondence Address: IBM CORPORATION, 2Y7/B656, PO BOX 12195, RESEARCH TRIANGLE PARK, NC, 27709, US

(21) Appl. No.: 09/791,371

(22) Filed: Feb. 23, 2001

Related U.S. Application Data
(63) Continuation-in-part of application No. 09/253,579, filed on Feb. 19, 1999.

(51) Int. Cl. G06F 13/00; G06F 13/38

(52) U.S. Cl. 710/129

(57) ABSTRACT

Vehicles such as airliners or trains can be equipped with a local area network in which individual network connections are made available at individual passenger seats using standard network connectors. Passengers having computers can connect to the network using their own conventional network connection cables. Wireless communications technology is used to link the vehicle network to external ground stations or satellite systems. To meet the DC power requirements of mobile computer users, the vehicle includes a DC power source. A normally unused wire-pair in the network connectors brings the DC power to each workstation. A slightly modified connector is used to transfer the DC power to the computer's DC power subsystem. The technology is adaptable to networks provided at more conventional, non-mobile, workstations.

### RELATED APPLICATIONS

This application is a Continuation-in-part of copending application Ser. No. 09/253,579 filed Feb. 19, 1999 and assigned to common ownership with the present subject application.

### FIELD AND BACKGROUND OF THE INVENTION

The present invention relates to computers and more particularly to an alternate power source for network-capable, ordinarily-mobile computers.

Early personal computers were desktop systems which were so heavy and so bulky that it was assumed they would be left in place once installed. However, the benefits of a transportable personal computer were recognized early on and considerable efforts have been made to develop lighter and more portable computers. The advent of new technologies has permitted the development of newer, smaller and lighter personal computers which are known by various names, such as notebook computers, laptop computers or even palmtop computers, depending on their relative size. Personal computers are now light enough and small enough that they can be carried as hand luggage and can be used almost anywhere, including the confines of most airline seats. Computers of this type are referred to generically as mobile computers in the following specification.

As mobile computers have come to be a preferred form of system for many users, capabilities have been developed for such systems to serve the dual purpose of replacing the formerly used desktop system and also serving the purposes of ready portability. Use of a notebook or laptop computer system as a desktop system now typically involves coupling the system to a docking station, and may include substituting a conventional “desktop” keyboard and pointing device for those provided in the mobile computer system. Even in such desktop uses, the power supply and network connection characteristics of the mobile computer, as described hereinafter, are retained.

Some users, having acquired a mobile computer small enough and light enough to carry on an airplane, want to be able to use that computer for the duration of even long flights either in a standalone mode and/or to stay “in touch” with others. Some airlines accommodate such users by installing what amounts to a local area network (LAN) in some of their airplanes. At least a limited number of the seats in the airplane are connected to the LAN through standard network connections, most commonly including telephone connections having a standard telephone jack such as the RJ45 jack widely used throughout the United States and in some other countries. The LAN includes a server or base station which can be used to establish data communications with ground-based stations or satellite systems. An authorized mobile computer user would access the LAN simply by plugging his modem or Ethernet cable into an RJ45 jack or the like located in an armrest or in the seatback or bulkhead ahead of him or her.

An airplane or other vehicle LAN is derived from the networking technology developed and widely used by the former desktop systems. In such networks, user workstations such as the mobile computer system here described are provided with network interface cards or NICs. By way of example, a NIC may enable connection to an Ethernet LAN, a token ring LAN, or through service akin to a Public Switched Telephone Service (PSTS). The last mentioned form of NIC is often referred to as a modem (modulator/demodulator). With a computer system primarily developed as a mobile system, the provision of a NIC is often accommodated by inserting a card into a peripheral bus such as a PCMCIA slot. However, some computer systems have NIC capability built into the housed assembly and thus do not require the insertion of a card into a peripheral slot or the like. The present invention contemplates that systems of all such types may find use as here described. The significant characteristics of the system are the provision of a NIC and a low voltage power supply connection. As here used, “low voltage” indicates some voltage below that conventionally supplied by electrical utility mains (in the United States, 110 volts).

While the existence of an airplane LAN and the ability to connect to that LAN through standard telephony connectors at an airplane seat will enable a mobile computer user to stay “in touch” with the outside world, that user will remain “in touch” only until his or her computer battery becomes discharged.

Even with the best battery technology currently available, it is not possible to operate most mobile computers for extended periods of time on battery power alone. Experienced travelers have attempted to avoid the problems of exhausted batteries by carrying spare batteries or even using the AC power outlet found in some airplane lavatories. Neither of these solutions is particularly appealing. Spare batteries are heavy and hard to install, particularly in the limited seating space available in most airplanes. An airplane lavatory is certainly not an ergonomically sound working environment and, in any event, is available on an extended basis only to a traveler who is willing to be totally indifferent to the discomfort of his or her fellow travelers.

### SUMMARY OF THE INVENTION

The present invention contemplates an alternate power source for a network-capable computer that can meet the needs of a computer-using traveler during long flights (or long ground vehicle trips) provided the vehicle is one of the type including a data network using standard telephony connectors for data distribution to users. The alternate power source is for use with any computer having a DC power subsystem and a NIC which can be connected to such a data network through a multi-wire connector having at least one available pair of wires. The alternate power source includes a pair of electrical leads which are connected at one end to the available pair of wires and which are coupled at the other end to an electrical interface to the DC power subsystem of the computer.

While particularly described with reference to such vehicular applications, the present invention further contemplates that the computer system may be powered from the network to which it is connected when used in an alternate, substitute for desktop, environment. Thus the technology available to the traveling user is made equally when that user is working at a more conventional workplace.

### BRIEF DESCRIPTION OF THE DRAWINGS

Some of the purposes of the invention having been stated, others will appear as the description proceeds, when taken in connection with the accompanying drawings, in which:

FIG. 1 is a simplified representation of a portion of vehicle interior, such as an airplane, including an internal network and wireless communications capabilities;

FIG. 2 is a similar representation of the same vehicle interior modified to support use of the present invention;

FIG. 3 is a block diagram of a conventional computer system showing conventional external connections both to an external data network and to an external AC power source;

FIG. 4 is a simplified representation of a conventional telephone connector such as the widely used RJ45 telephone connector;

FIG. 5 is a simplified representation of an RJ45 telephone connector modified to implement the present invention;

FIG. 6 represents one embodiment for an electrical interface between a modified RJ45 telephone connector and the DC power subsystem of a computer; and

FIG. 7 represents an alternate embodiment for an electrical interface between a modified RJ45 telephone connector and the DC power subsystem of a computer.

### DESCRIPTION OF THE PREFERRED EMBODIMENT(S)

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

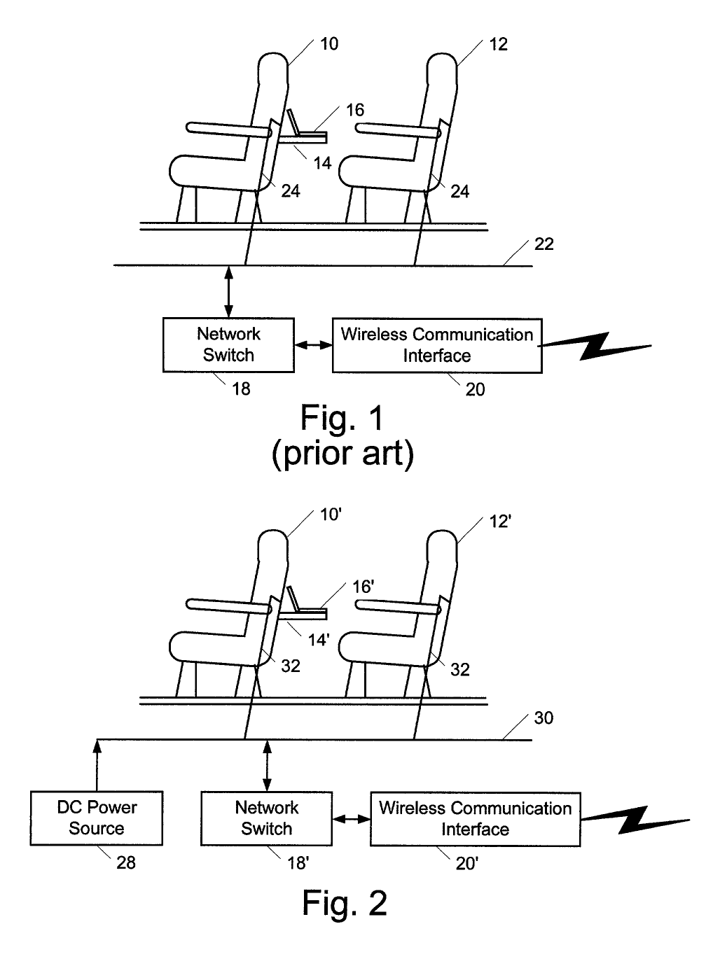

FIG. 1 is shows a portion of a vehicle interior. For the sake of convenience, the vehicle will be referred to as an airliner although it could be any kind of air, land or water vehicle equipped with the elements described below. Two passenger seats 10 and 12 are shown. The passenger seats are conventional to the extent they include fold-down tray tables, such as tray table 16, which passengers can use for food service and to support books, papers or even a mobile computer, such as mobile computer 16.

The passenger seats are unconventional in that they are equipped with wires 24 leading to a network switch 18 located in a non-passenger area of the airliner. Network switch 18 is itself connected to a wireless transceiver 20 which can both send data to and receive data from ground stations (not shown) or satellites (also not shown) linked to terrestrial data networks. In a preferred type of implementation, a shared media 22 is used to interconnect the individual seatback wires 24 to the network switch 18, although direct connections between each seat and the network switch are well within the scope of the present invention.

To make the system useful to as many travelers as possible, standard network connections are employed at each seatback. Since network-capable mobile computers are often equipped with a standard telephone cable which can be used to complete a data connection between a standard telephone jack on the mobile computer and a standard telephone wall jack leading to a private or public switched telephone network, advantage may be taken of such provision. In the illustrated environment, the seatback jack takes the place of a wall jack and the network switch takes the place of the switched telephone network or PSTS. A standard network connection offered at a seatback or at an alternative workplace such as an office desk may be any of the other forms of network connections mentioned herein.

While the described environment can satisfy a traveler's desire to get “in touch” with others during even long airline flights, the traveler nevertheless can stay in touch only so long as his mobile computer battery (or batteries) retain a sufficient charge.

Referring to FIG. 2, to eliminate the dependence of the traveler on battery power, the present invention requires that the described environment be modified by including a low voltage (generally 12 volts or less) DC power source 28 in the airliner. As will be described in more detail below, the DC power source 28 can be used to provide DC power to mobile computer users through a shared media 30 and individual seatback connections 32. Many of the elements shown in FIG. 2 are substantially unchanged from the form they have in the FIG. 1 environment, which is indicated by the use of primes with certain of the reference numbers. The media 30 and seatback connections 32 are designated by new reference numbers to indicate that they perform new functions in the FIG. 2 environment. As indicated above, the seatback connections 32 or other workplace service connections may take any of the various forms here described. Further, while only a single computer system 16 is illustrated in FIG. 2, it will be understood that a single vehicle or other work environment may accommodate a plurality of computer systems in use by a number of workers.

Where desired or appropriate, power distribution controls may be implemented in the DC power source 28 and shared media 30 to deal with potentially excessive power demands. Such potentially excessive power demands can be controlled by either interrupting power supply, compelling any attached computer systems so equipped to rely on battery power, or selectively “powering down” identified seat connections to enable some computer systems to continue to be powered by the DC source 28 while others become disconnected therefrom.

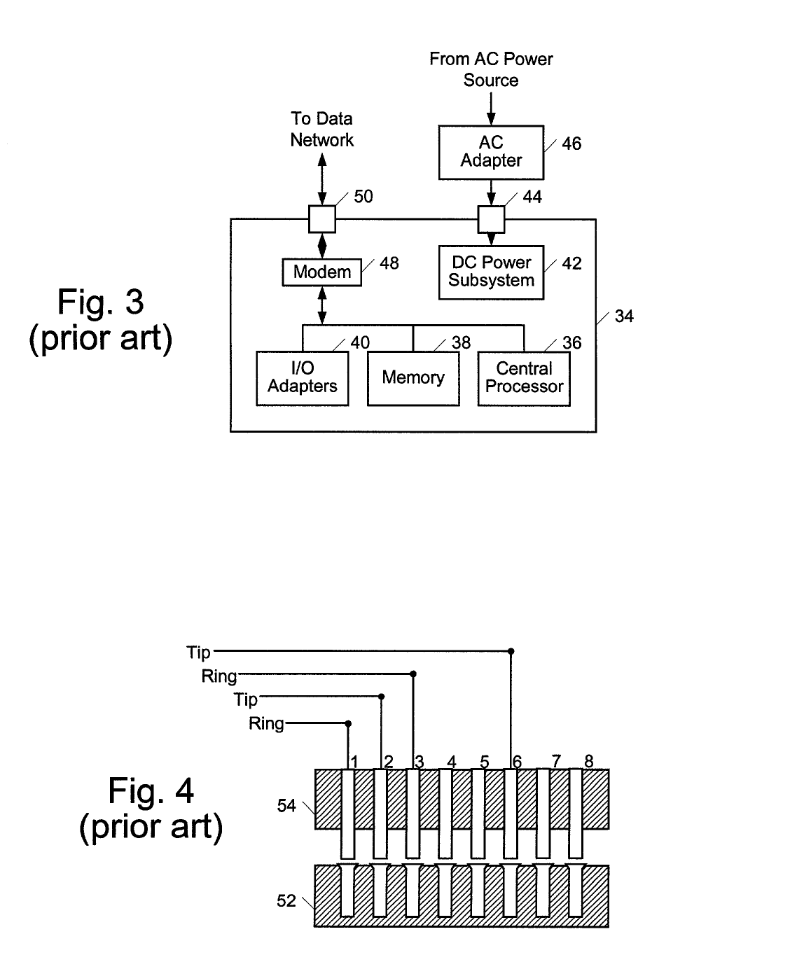

FIG. 3 is a block diagram of a standard mobile computer 34 which can be used in implementing the present invention. The computer is conventional in that it includes a central processor 36, memory elements 38, input/output (I/O) adapters 40 and a DC power subsystem 42. While a conventional desktop system usually includes a three-prong jack for receiving a grounded 110 volt power plug, a mobile system usually has a removable DC power plug 44 connected to an AC adapter 46. Typically, the DC power provided by the AC adapter 46 is used both to power the mobile computer system and to restore the charge on a rechargeable battery (not shown) within the DC power subsystem 42.

It is common to include a NIC in a mobile computer either as an integral permanent component or in the form of a pluggable component complying with the requirements of a known standard such as the PCMCIA standard. Most NICs provided in such circumstances are modems, although NICs capable of other network connection technologies are also provided. Most modems, whether fixed or pluggable, are terminated externally using a standard telephony connector 50 such as the ubiquitous RJ45 telephone jack.

FIG. 4 is a simplified representation of a standard RJ45 telephone connector, having a jack 52 can receive a complementary plug 54 which terminates conventional telephone twisted pair (TP) wires. It should be noted that the drawing is only a logical representation of an RJ45 connector, not a physical representation. An actual RJ45 connector is a much more complex physical structure than the structure illustrated. A standard telephony connector includes four pairs of electrical contacts. A one line telephone or standard single modem connection is connected using wires terminating at only one of the three pairs, usually the wire pair (1-2) in the plug. It is standard practice to designate the wire pair connections as “tip” and “ring” leads to identify telephony functions which are performed by signals carried on the leads. Where a two line telephone or a second telephone phone is to be installed, a second conductor (and wire) pair (usually 3-6) is used. The third and fourth conductor pairs are rarely used for any purpose. Many conventional telephone cables don't even include wires connected to the third and fourth conductor pairs.

The present invention capitalizes on the fact that one wire pair (4-5) in a standard RJ45 connector is rarely used. The invention appropriates that wire pair to provide an electrical connection between the DC power source 28 and a plug 56. A complementary jack 58 includes a conventional wire pair (1 -2) connection to an internal or pluggable modem 60, but also includes an unconventional wire pair (4-5) connection. This wire pair is used to carry DC power to the computer's DC power subsystem. The amount of DC power that can be transported over telephone twisted pair wiring is great enough to supply the power needs of the mobile computer system and may be sufficient to trickle-charge the computer's battery even while the computer is in active use.

FIG. 6 depicts a first specific embodiment of the invention. In that Figure, the network connection and the DC power source are represented generically as a signal/power source 66. In this embodiment, the wire-pair 4-5 is connected directly to the DC power subsystem 64 of the computer. This embodiment assumes, of course, that the computer was initially designed to support such a direct connection.

FIG. 7 depicts a second specific embodiment which would permit the invention to be used with currently available mobile computers. In the second embodiment, the plug to be inserted into the computer telephone jack is modified to carry a pair of electrical leads which are terminated in a DC power plug 66 of the type already commonly found on mobile computers. DC power would be transferred to the computer's DC power subsystem 64 using the DC power plug 68 and a complementary jack 70 in exactly the same way those components are normally used to transfer power provided by an AC adapter.

The apparatus of FIG. 7 includes an elongate cable which is terminated at one end in a network connector 57 appropriate for connection to the LAN provided in either a mobile or more conventional workplace, bifurcated between its ends, and terminated at the other ends in two connectors, one connector 58 adapted for connection to the NIC provided and one connector 68 adapted for connection to the mobile computer system's power input. The advantage of this embodiment is that no changes are required within the computer itself in order to make use of the invention.

While there have been described what are considered to be preferred embodiments of the present invention, variations and modifications in the preferred embodiments will occur to those skilled in the art once they are made aware of the invention. As just one example, the invention could readily be used with network connectors other than the standard PSTS RJ45 connector. Therefore, it is intended that the appended claims shall be construed to include not only the preferred embodiments but all such variations and modifications that fall within the true spirit and scope of the invention.

In the drawings and specifications there have been set forth preferred embodiments of the invention and, although specific terms are used, the description thus given uses terminology in a generic and descriptive sense only and not for purposes of limitation.

What is claimed is:

1. Apparatus comprising:
a computer system having a DC power subsystem with an electrical interface through which low-voltage power may be supplied to said mobile computer system,
a network interface card mounted in said computer system and coupleable to an external network to direct data flow to and from said computer system, and
an elongate three-ended cable terminated at one end in a first network connector appropriate for connection to an external network, said cable being bifurcated between said one end and the remaining other ends and terminated at said other ends in two other connectors, one of said two other connectors being a second network connector appropriate for connection to said network interface card of a computer system and the other of said two other connectors being a power connector appropriate for connection to said electrical interface.

2. Apparatus as claimed in claim 1 wherein the electrical interface to the DC power subsystem includes an electrical socket capable of receiving a DC power supply connector and said other of said two other connectors is a DC power supply plug.

3. Apparatus comprising:
a computer system having a DC power subsystem with an electrical interface through which low-voltage power may be supplied to said mobile computer system,
an interface card mounted in said computer system and coupleable to an external network to direct data flow to and from said computer system, said interface card coupled to said DC power subsystem to direct electrical power thereto, and
an elongate cable terminated at one end in a first network connector appropriate for connection to an external network and terminated at an opposite end in a second network connector appropriate for connection to said network interface card.

4. Apparatus as claimed in claim 3 wherein the electrical interface to the DC power subsystem includes electrical conductors capable of receiving DC power and extending between said interface card and said DC power subsystem.

5. Apparatus comprising:
a plurality of computer systems, each having a DC power subsystem, a network interface card, and a multi-wire network connector, each of said multi-wire network connectors having a set of electrical leads coupled to the DC power subsystem to enable external DC power to be applied to the DC power subsystem through an available set of contacts in said multi-wire network connector;
a DC power source; and
a power distribution system for connecting the DC power source to pairs of available contacts in a plurality of network connectors complementary to the network connectors in each of the plurality of computers.

6. Apparatus as claimed in claim 5 further including a network device connected to said plurality of computer systems through a different pair of wires in said multi-wire network connectors.

7. Apparatus as claimed in claim 6 wherein at least one of the plurality of computers includes an electrical socket and said alternate power source further includes a DC power supply jack connected to said pair of electrical leads and receivable in the electrical socket.

8. Apparatus comprising an elongate three-ended cable terminated at one end in a first network connector appropriate for connection to a LAN, said cable being bifurcated between said one end and the remaining other ends and terminated at said other ends in two other connectors, one of said two other connectors being a second network connector appropriate for connection to a network interface card of a computer system and the other of said two other connectors being a power connector appropriate for connection to a power input of a computer system.
